(19) United States
(12) Patent Application Publication
(10) Pub. No.: US 2023/0171291 A1
(43) Pub. Date: Jun. 1, 2023

(54) TIERING TO GROUP AND ACCESS CONTROL CLOUD NATIVE SECURITY POLICIES

(71) Applicant: VMware, Inc., Palo Alto, CA (US)

(72) Inventors: Abhishek Raut, San Jose, CA (US); Yang Ding, San Jose, CA (US); Kai Su, Foster City, CA (US); Donghai Han, Beijing (CN); Zhengsheng Zhou, Beijing (CN); Wenfeng Liu, Beijing (CN)

(21) Appl. No.: 17/570,354

(22) Filed: Jan. 6, 2022

(30) Foreign Application Priority Data
Nov. 29, 2021 (CN) PCT/CN2021/134088

(51) Int. Cl. H04L 9/40

(52) U.S. Cl. CPC H04L 63/20

(57) ABSTRACT

Methods, systems, and apparatus, including computer programs encoded on computer storage media, for managing access to network security policies. One of the methods includes determining, for a policy access request i) received from a device and ii) that requests access to a network security policy that defines a rule for controlling network traffic, whether there is an entitlement for the network security policy, wherein the entitlement indicates one or more types of operations that a subset of user accounts can perform on the network security policy; in response to determining that there is an entitlement, determining, using a mapping for the entitlement that identifies the subset of user accounts that have access to the network security policy, whether a user account for the device is included in the subset of user accounts; and selectively allowing or denying the policy access request using the entitlement and a result of the determination.

### BACKGROUND

This specification relates to network security policy access, e.g., using tiers.

Some systems can use network security policies to control access with various resources. For instance, a system can use a network security policy to monitor, control, or both, network traffic to and from network based resources.

### SUMMARY

In general, one aspect of the subject matter described in this specification can be embodied in methods that include the actions of determining, for a policy access request i) received from a device and ii) that requests access to a network security policy that defines a rule for controlling network traffic, whether there is an entitlement for the network security policy, the entitlement can indicate one or more types of operations that a subset of user accounts can perform on the network security policy; in response to determining that there is an entitlement for the network security policy, determining, using a mapping for the entitlement that identifies the subset of user accounts that have access to the network security policy, whether a user account for the device is included in the subset of user accounts that have access to the network security policy; and selectively allowing or denying the policy access request using the entitlement that indicates the one or more types of operations that a subset of user accounts can perform on the network security policy and a result of the determination whether the user account for the device is included in the subset of user accounts that have access to the network security policy. Other embodiments of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations, the method can include in response to determining that the user account for the device is not included in the subset of user accounts that have access to the network security policy, denying the policy access request. Denying the policy access request can include preventing access to the network security policy.

In some implementations, the method can include receiving, the policy access request including at least one of a network security policy identifier, a tier identifier, or an operation type, the operation type can include one of create, read, update, or delete. The policy access request can include an operation type, the method can include in response to determining that the operation type of the policy access request is not included in the one or more types of operations indicated in the entitlement for the network security policy, denying the policy access request.

In some implementations, the method can include in response to determining that i) the user account for the device is included in the subset of user accounts that have access to the network security policy and ii) an operation type of the policy access request is included in the one or more types of operations indicated in the entitlement for the network security policy, allowing the user account to access the network security policy.

In some implementations, a first tier can include a first collection of network security policies that include the network security policy, the entitlement can be created for the first tier to associate the first tier with the one or more types of operations that can be performed on the first collection of network security polices by the subset of user accounts, a first entitlement binding can indicate an authorization for the subset of user accounts to access the first collection of network security policies in the first tier, and determining whether there is an entitlement for the network security policy can include determining whether an entitlement is created for the first tier that includes the network security policy.

In some implementations, a second tier can include a second collection of network security policies, a second entitlement can be created for the second tier to associate the second tier with one or more types of operations that can be performed on the second collection of network security policies by a second subset of user accounts, and a second entitlement binding can indicate an authorization for the second subset of user accounts to access the second collection of network security policies in the second tier. The first tier can be associated with a first priority that is higher than a second priority associated with the second tier, and during control of network traffic, the first collection of network security policies in the first tier can be applied before the second collection of network security policies because the first tier has the first priority that is higher than the second priority for the second tier.

In some implementations, determining, using the mapping, whether the user account for the device is included in the subset of user accounts that have access to the network security policy can include determining, using the first entitlement binding, whether the user account for the device is included in the subset of user accounts that are authorized for the first tier.

In some implementations, the method can include creating the first entitlement binding that indicates the authorization for the subset of user accounts to access the first collection of network security policies using data that identifies the subset of user accounts and the entitlement, the mapping that identifies the subset of user accounts that have access to the network security policy can include the first entitlement binding.

In some implementations, the method can include determining, for a second policy access request i) received from a second device and ii) that requests access to a second network security policy that defines a second rule for controlling network traffic, whether there is a second entitlement a) for the second network security policy b) that indicates one or more second types of operations that a second subset of user accounts can perform on the second network security policy; and in response to determining that there is no second entitlement for the network security policy, allowing the policy access request.

In some implementations, a method can include maintaining, in a database: first data for a network security policy that (i) defines a rule for controlling network traffic and (ii) is associated with a single tier in a plurality of tiers of network security policies, second data for each tier in the plurality of tiers of network security policies that indicates an entitlement for the tier, wherein the entitlement identifies one or more types of operations that a corresponding subset of user accounts can perform on the network security policies included in the tier, and third data for an entitlement binding (a) for an entitlement from a plurality of entitlements (b) that identifies the corresponding subset of user accounts that can perform the one or more types of operations identified by the entitlement; determining, for a policy access request i) received from a device and ii) that requests access to a second network security policy, whether there is an entitlement for the second network security policy in the database; and in response to determining that there is no entitlement for the second network security policy in the database, allowing the policy access request.

The subject matter described in this specification can be implemented in various embodiments and may result in one or more of the following advantages. In some implementations, a security system that manages network security policy access can group network security policies into different tiers, and define one or more types of operations allowed for the network security policies within each tier by creating an entitlement for the tier to improve system security compared to other systems. In some implementations, a security system can restrict access to the network security policies in each tier to a subset of user accounts, e.g., administrative user accounts, by creating an entitlement binding for each tier, e.g., to improve system security compared to other systems. In some implementations, a security system can limit which types of operations can be performed on each network security policy by which user accounts using tiers, which can improve system security compared to other systems. Any one or more of these features can improve the security of the security system, the system that uses the network security policies, or both.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of a computing system that can be used to manage network security policy access.

FIG. 2 is a block diagram of structure components for using tiers to manage network security policy access.

FIG. 3 is a flow diagram of an example process for managing network security policy access.

Like reference numbers and designations in the various drawings indicate like elements.

### DETAILED DESCRIPTION

In a network system, there can be many different users with different roles. For example, in a cloud system using cluster networking, network security policies can be managed by different administrative users. For example, a security operations administrator may manage the network security policies on external traffic to prevent external threats. A namespace administrator may manage the network security policies on domain name system (“DNS”) traffic.

However, if there is no restriction on the access to the different network security policies, an administrative user might be able to modify network security policies that another administrative user created and should not be modified by them. For instance, an administrator managing DNS traffic policies can edit or overwrite external traffic policies that a security operations administrator created and only other security operations administrators should be able to edit.

To address this, a security system can restrict the access to network security policies that define rules for controlling network traffic. The security system can group network security policies into different tiers, and define one or more types of operations allowed for the network security policies within each tier. The security system can restrict access to the network security policies in each tier to a subset of user accounts, e.g., where each account is for a corresponding administrative user. The security system can define the one or more types of operations allowed for the network security policies within each tier by creating an entitlement for each tier, as described in more detail below.

For example, a first tier can include a first collection of network security policies, each of which can prevent a known external threat. A second tier can include a second collection of network security policies that authorize all DNS traffic, among other rules. The security system can associate subsets of users, e.g., administrators, with each tier and restrict access network security policies in that tier to that subset of users. The security system can make this association by creating an entitlement binding for the entitlement of the tier, as described in more detail below. This can improve the security of the security system, the system that uses the network security policies, or both, by limiting which administrators have access to, and can edit, which network security policies. The security system can create the entitlement binding alongside the creation of the corresponding entitlement for the tier, e.g., as part of the same process. The security system can create, for a tier, multiple entitlements, each of which have a corresponding entitlement binding with different respective sets of user accounts so that the different sets of user accounts have different operations that they can or cannot perform on the network security policies in the tier.

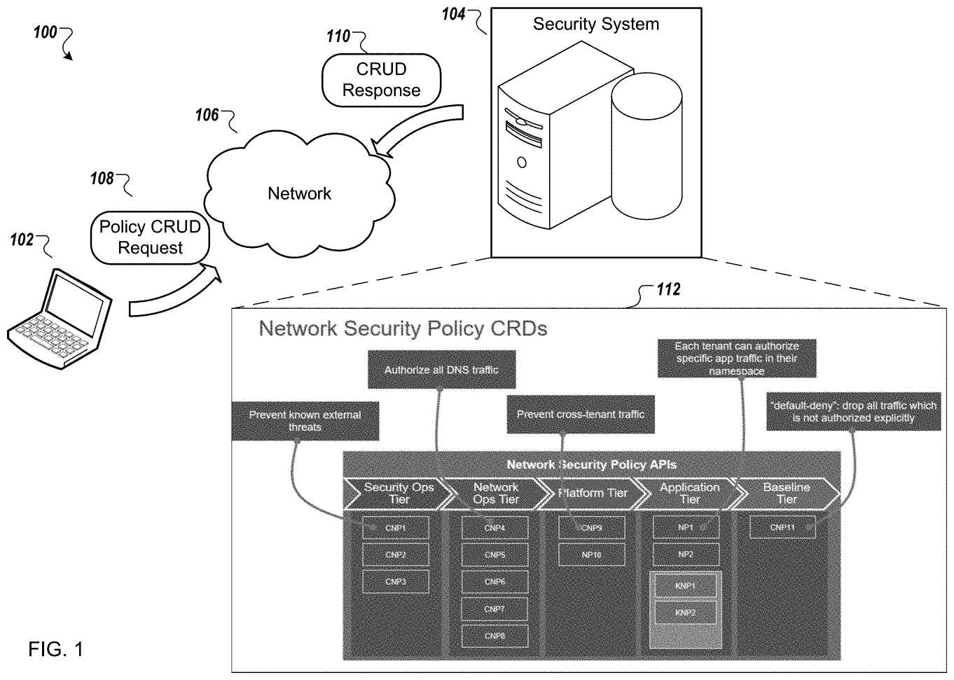

FIG. 1 is a block diagram of a computing system 100 that can be used to manage network security policy access. The computing system 100 can include one or more user devices 102 and a security system 104 including one or more servers, that are connected over a network 106.

The security system 104 can receive a policy access request. In some examples, a policy access request can be a policy to create, read, update, or delete (CRUD) request 108, which requests to create, read, update, or delete, respectively, a network security policy, from a user device 102 over the network 106. Although this specification refers to the policy access request as a policy CRUD request 108, the policy access request can be any other appropriate type of request. Similarly, although this specification refers to a response as a CRUD response 110, the security system 104 can send any other appropriate type of response. The security system 104 can determine whether to allow or deny the policy CRUD request 108 and return a CRUD response 110 to the user device 102 over the network 106 that indicates the allow or deny decision.

The security system 104 can group a plurality of network security policies into different tiers and use data for the tiers when determining whether to allow or deny the policy CRUD request 108. Each network security policy can be associated with only one tier. The different tiers can form a hierarchy structure. The security system can maintain the policy hierarchy structure 112 in one or more databases.

The policy hierarchy structure 112 includes a plurality of tiers, with each tier including a collection of network security policies. In the example shown in FIG. 1, there are 5 tiers: a Security Operations Tier, a Network Operations Tier, a Platform Tier, an Application Tier, and a Baseline Tier. In Security Operation Tier, there are three network security policies: CNP1, CNP2, and CNP3. Similarly, the other tiers have their own respective network security policies, which network security policies are not included in any of the other tiers.

In some implementations, each tier is associated with a priority. The network security policies in a higher-priority tier have high priorities over the network security policies in a lower-priority tier. During evaluation of network traffic, the security system 104 evaluates the network security policies in high-priority tiers against the network traffic before evaluating the network security policies in lower-priority tiers.

In the example shown in FIG. 1, the five tiers, e.g., Security Operations Tier, Network Operations Tier, Platform Tier, Application Tier, and Baseline Tier, are organized with their priorities decreasing. Security Operations Tier has the highest priority, and the Baseline Tier has the lowest priority. During evaluation of a network traffic packet, the security system 104 can evaluate policies in the Security Operations Tier first against the packet. If the security system 104 determines that a policy in the Security Operations Tier applies to the packet, the security system 104 processes the packet according to the determined policy. If no applicable policy in the Security Operations Tier is found, the security system 104 can evaluate the next tier policies to determine whether a policy in the next tier, e.g., the Network Operations Tier, applies to the packet. The rule evaluation will continue until the security system 104 finds an applicable network policy or applies a default policy if no other policy applies. For instance, if the security system 104 does not find an applicable policy after evaluating all tier policies, e.g., other than the Baseline Tier, the security system 104 can enforce a default action.

The security system 104 can create an entitlement for each tier to associate the tier with one or more types of operations that can be performed on the collection of network security policies included in that tier by a subset of user accounts. The creation of entitlement for a tier can indicate that access to network security policies in that tier is restricted, e.g., that not all user accounts have access to the policies in the tier. If there is no entitlement for a tier, the network security policies in the tier can be accessed by any user account. The one or more types of operations defined by the entitlement can be operations that the security system 104 allows to be performed on the network security policies included in the tier, and the security system 104 can allow these operations to be performed only by authorized user accounts for the tier.

The security system 104 can create an entitlement binding for each entitlement. The entitlement binding for the entitlement can identify the corresponding subset of user accounts, e.g., authorized user accounts, that can perform the one or more types of operations identified by the entitlement.

The security system 104 can restrict the access to different network security policies by utilizing the entitlement and the entitlement binding. In some examples, only user accounts bound with a tier, as defined in the entitlement binding, can perform operations on the network security policies in the tier. In some implementations, a user account can only perform the types of operations defined in the tier entitlement that is associated with the entitlement binding that identifies the user account.

In some examples, the security system 104 can restrict access to the network security policies in a tier can by allowing some user accounts to only view the network security policies included in the tier. In some examples, the security system 104 can restrict access to the network security policies in a tier by allowing some user accounts to create, read, update, delete, or a combination of two or more of these, the network security policies in the tier. For instance, the security system 104 can improve network security by preventing some user accounts from viewing network security policies in a tier; by limiting some user accounts to only view network security policies in a tier but not allowing CRUD operations; by limiting some user accounts to create network security policies in a tier, but not update or delete network security policies in the tier; or a combination of two or more of these.

After the security system 104 receives the policy CRUD request 108, the security system 104 can determine whether the user account is authorized to access the requested network security policy based on the entitlement binding. For instance, the security system 104 can use the policy CRUD request 108 to determine an identifier for the network security policy identified by the policy CRUD request. In some examples, the CRUD request includes the identifier. In some examples, the security system 104 uses data for the network security policy that is included in the CRUD request, e.g., a policy name, to determine the identifier, e.g., by accessing a database.

The security system 104 can use the identifier for the network security policy to determine a tier to which the network security policy belongs. For instance, the security system 104 can access a database that includes data for the policy hierarchy structure 112 to determine the tier to which the network security policy belongs.

The security system 104 uses data for the determined tier to determine whether the tier has an entitlement. The security system 104 can access a mapping, e.g., stored in a database, that associates a tier with one or more entitlements. The security system 104 can use the mapping to determine whether the tier has an entitlement.

If the security system 104 determines that the tier does not have an entitlement, the security system 104 can determine to allow the policy CRUD request 108. For instance, the security system 104 can send a CRUD response 110 that indicates that access is allowed, allow the user device 102 access to the requested network security policy, or both.

If the security system 104 determines that the tier has an entitlement, the security system 104 can determine an entitlement binding for the entitlement. For example, the security system 104 can access a database that indicates the entitlement binding, and one or more user accounts for the entitlement binding.

To determine whether the user account, e.g., for the user device 102 from which the security system 104 received the policy CRUD request 108, is authorized to access the requested network security policy, the security system 104 determines whether the user account matches one of the user accounts for the entitlement binding. The security system 104 can make this determination by comparing the names of the user account for the user device 102 to the names for the user accounts identified by the entitlement binding, by comparing corresponding user account identifiers, or using any other appropriate process.

The security system 104 can determine whether the operation type of the policy CRUD request 108 is one of the allowable operation types based on the entitlement. For a network security policy in a tier with an entitlement, e.g., the access of the policy is restricted, when the user account is authorized and the operation type is allowable, the security system 104 can allow the user device 102 to access the network security policy. Otherwise, the security system 104 can deny the user device 102 to access the network security policy.

For a network security policy without entitlement, e.g., the access of the policy is not restricted, the security system 104 can allow the user device 102 to access the network security policy. The security system 104 can send the positive or negative result in the CRUD response 110 to the user device 102 over the network 106.

In some implementations, the security system 104 can store the network security policies including rules of controlling network traffic in one or more database. The security system 104 can store one or more of the entitlement data, the entitlement binding data, the hierarchy structure, the policy-tier association data, the priority data, and any other relevant data for managing network security policy access in the one or more databases.

The user devices 102 may include personal computers, mobile communication devices, and other devices that can send and receive data over the network 106. The network 106, such as a local area network (“LAN”), wide area network (“WAN”), the Internet, or a combination thereof, connects the user devices 102 and the servers of the security system 104.

The one or more user devices 102 can be an example of a system implemented as computer programs on one or more computers in one or more locations, in which the systems, components, and techniques described in this specification are implemented. The user devices 102 may include personal computers, mobile communication devices, and other devices that can send and receive data over a network 106. The network 106, such as a local area network (“LAN”), wide area network (“WAN”), the Internet, or a combination thereof, connects the user devices 102 and the servers of the security system 104. The one or more servers of the security system 104 may use a single server computer or multiple server computers operating in conjunction with one another, including, for example, a set of remote computers deployed as a cloud computing service.

The security system 104 including one or more servers can include several different functional components, including an entitlement component, and an entitlement binding component. The entitlement component and the entitlement binding component, or a combination of these, can include one or more data processing apparatuses. For instance, each of the entitlement component and the entitlement binding component can include one or more data processors and instructions that cause the one or more data processors to perform the operations discussed herein.

The various functional components of the security system 104 may be installed on one or more computers as separate functional components or as different modules of a same functional component. For example, the entitlement component and the entitlement binding component of the security system 104 can be implemented as computer programs installed on one or more computers in one or more locations that are coupled to each through a network. In cloud-based systems for example, these components can be implemented by individual computing nodes of a distributed computing system.

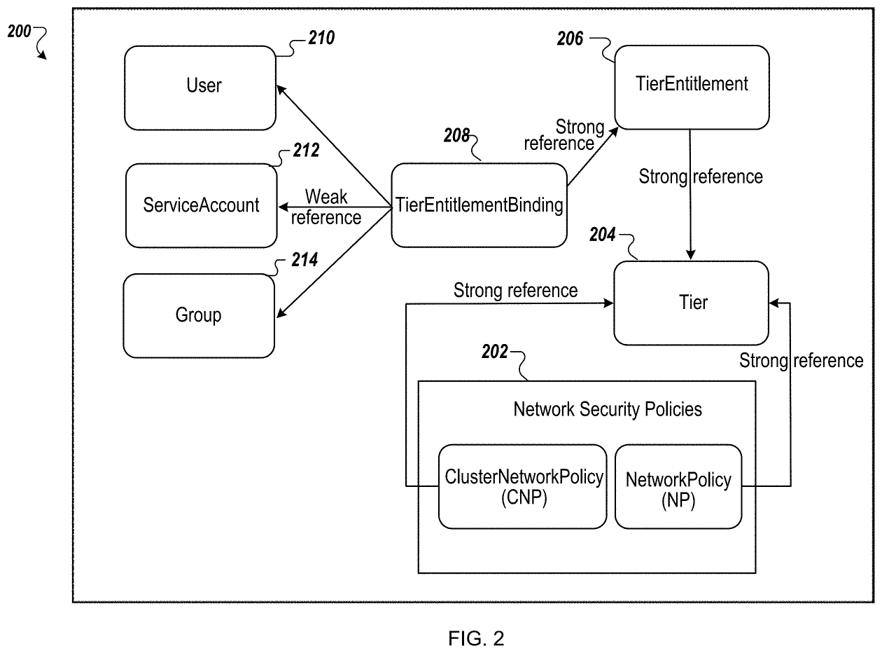

FIG. 2 is a block diagram of structure components 200 for using tiers to manage network security policy access. For instance, the structure components can be components within one or more databases that store data for the network security policies, tiers, entitlements, entitlement bindings, user accounts, or a combination of two or more of these. Although this specification generally refers to user accounts, a user account can be for a particular user, a service account, or a group account. As shown in the figure, the network security policies 202, such as CNP and NP, are grouped into tiers 204. The CNP and NP are provided as examples, and a security system can use any other network security policies.

The tiers 204 can be associated with a tier entitlement 206. A security system can have a mapping that associates the tiers 204 with one or more tier entitlement 206.

For each tier entitlement 206, the security system can create a tier entitlement binding 208 to bind a list of authorized users 210, service accounts 212, or groups 214 to an existing tier entitlement 206.

In some implementations, the security system can connect one or more of the components with a strong reference or a weak reference. A strong reference can indicate that, to create a source component, the security system should have a corresponding target component. In some examples, a weak reference can indicate that, to create a source component, the security system need not have a corresponding target component. For example, when defining the tier entitlement binding 208 as a source component, the target tier entitlement 206 as a target component must exist, but the referenced users 210, service accounts 212, or groups 214 as other target components might not exist.

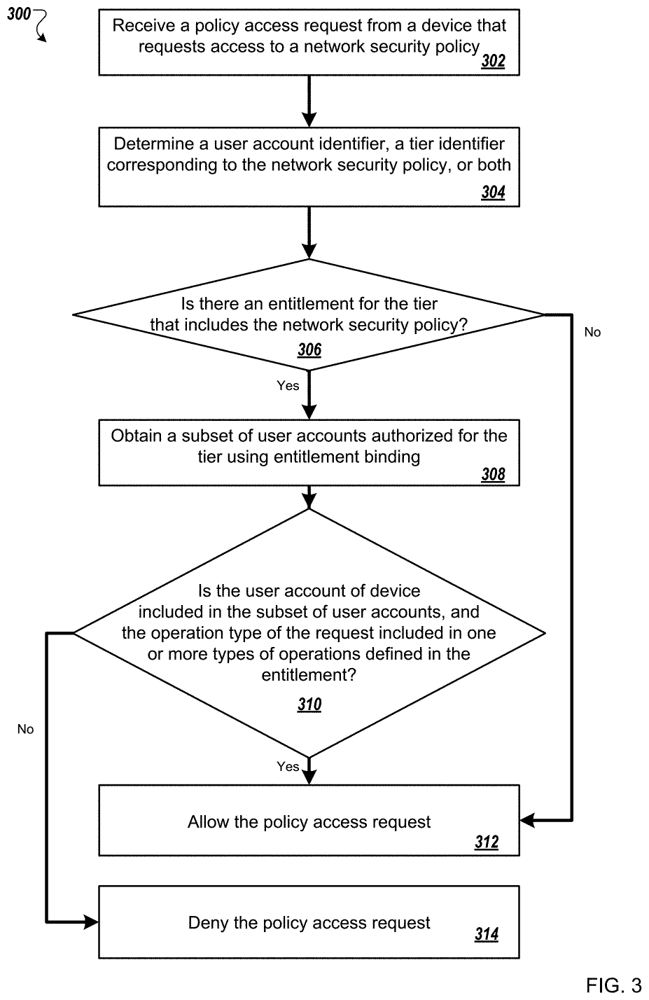

FIG. 3 is a flow diagram of an example process 300 for managing network security policy access. For example, the process 300 can be used by the security system 104 from the environment 100.

At step 302, the security system receives, from a device, a policy access request that requests access to a network security policy. The network security policy may define a rule for controlling network traffic in a system. The security system or another system can control the system's network traffic using multiple network security policies, including the network security policy. The policy access request can include at least one of a network security policy identifier, a tier identifier, or an operation type. The operation type can include one of create, read, update, or delete. In some examples, the policy access request can include a user account identifier for the device. The user account identifier can be for a user account that is logged in on the device and for which the device sent the policy access request.

For example, the security system may receive a request indicating that an administrator with the user account requests to create a new network security policy named “Policy A” in a particular tier, say “Tier T.” In this example, the network security policy identifier is “Policy A,” the tier identifier is “Tier T,” and the operation type is “create.” In another example, the request can indicate that an administrator with the user account requests to “delete” an existing policy named “Policy B.” In this example, the access request does not include the tier identifier. The security system can determine the tier identifier (“ID”) corresponding to the policy, e.g., Tier U, which is the tier that includes “Policy B.”

At step 304, the security system determines the user account identifier for the device, a tier identifier corresponding to the network security policy, or both. For example, the security system can determine the user account for the device using the account identifier logged into by the administrator who issued the access request.

The security system can use any appropriate process to determine the tier identifier. For instance, the security system can extract the tier identifier from the access request. The security system can determine the tier identifier using the policy identifier included in the request. For example, the security system can extract the tier ID from the access request directly, if the access request includes the tier ID. The security system can determine the tier ID based on policy-tier association data, e.g., using data that maps multiple network security policies to a respective tier from multiple tiers.

The policy-tier association data can include data for different network security policies associated with a plurality of tiers, with each tier including a collection of network security policies. For example, a first tier can include a first collection of network security policies, each of which can prevent a known external threat. A second tier can include a second collection of network security policies that authorize all DNS traffic, among other rules. In some examples, the policy-tier data, or other policy data, tier data, or both, can include priority data for the tier, a policy, or both.

The network security policies in a higher-priority tier have high priorities over the network security policies in a lower-priority tier. For example, the first tier may have a higher priority; while the second tier may have a lower priority. During controlling of network traffic, a system applies the first collection of network security policies in the first tier before the second collection of network security policies being applied.

In some implementations, policy data for a network security policy can include the rules of the policy for controlling network traffic. The policy data can include priority data for the policy.

The policy-tier association data can indicate an association, e.g., mapping, between the network security policy, e.g., policy data, and a single tier, from multiple tiers maintained by the security system. In some examples, each network security policy can be associated with only one tier. In some implementations, the security system can create the association of a tier with a network security policy by including an identifier for the network security policy in a tier definition.

Using the policy identifier included in the access request, the security system can refer to the policy-tier association data and determine which tier includes, e.g., tier identifier is associated with, the policy to be accessed in the access request. For example, the security system can determine that the network security policy included in the request corresponds to a first tier, a second tier, or a third tier.

At step 306, the security system can determine whether there is an entitlement for the tier that includes the network security policy. The entitlement indicates one or more types of operations that a subset of user accounts can perform on the network security policy. In some examples, the entitlement itself does not identify the subset of user accounts. Instead, the entitlement might just indicate the one or more types of operations.

In some implementations, the security system can create an entitlement for a tier to associate the tier with one or more types of operations that can be performed on the collection of network security policies included in that tier by a subset of user accounts. For example, the security system can create a first entitlement for the first tier including a first collection of network security policies, which include the network security policy to be accessed. The first entitlement can associate the first tier with one or more first types of operations that can be performed on the first collection of network security policies by a first subset of user accounts. Similarly, a second entitlement can be created for a second tier including a second collection of network security policies. The second entitlement can associate the second tier with one or more second types of operations that can be performed on the second collection of network security policies by a second subset of user accounts.

For example, the first entitlement can associate the first tier with one or more first types of operations, such as “read” and “create.” In this example, the first entitlement indicates that only authorized user accounts, e.g., a subset of user accounts, for the first tier are allowed to “read” or “create” network security policies in the first tier. In some examples, the second entitlement can associate the second tier with one or more second types of operations, such as “create,” “update,” and “delete.” In this example, the second entitlement indicates that only authorized user accounts for the second tier are allowed to “create,” “update” or “delete” the network security polices in the second tier. Thus, the creation of an entitlement for a tier can indicate that the access to network security policies in that tier are restricted. If there is no entitlement for a tier, the network security policies in the tier can be accessed by any user account in the security system.

In some implementations, the security system can maintain entitlement data in the one or more databases. The entitlement data can include an entitlement status, e.g., existing or not existing, for each tier. In some examples, the entitlement data can identify one or more types of operations for the tier, such as create, read, update, delete, or a combination of two or more of these. The one or more types of operations are allowed to be performed on the network security policies included in the tier to which the entitlement data corresponds, and the operations are allowed to be performed only by authorized user accounts for the tier.

In some implementations, the security system can maintain entitlement binding data in the one or more databases. The entitlement binding data can include the list of authorized user accounts for each tier that is associated with an entitlement. For example, an entitlement binding can be for a particular entitlement from a plurality of entitlements, and the entitlement binding for the particular entitlement can identify the corresponding subset of user accounts, e.g., authorized user accounts, that can perform the one or more types of operations identified by the particular entitlement to the policies in the corresponding tier. For example, a first entitlement binding can be created, for the first entitlement of the first tier, to indicate an authorization for a first subset of user accounts to access the first collection of network security policies in the first tier. A second entitlement binding can be created, for the second entitlement of the second tier, to indicate an authorization for the second subset of user accounts to access the second collection of network security policies in the second tier.

The security system can determine whether there is an entitlement for the tier including the network security policy by determining whether an entitlement is created for the tier, e.g., whether entitlement data for the tier exists in the one or more databases. The security system can refer to the entitlement status, e.g., existing or not existing, for each tier in the database to make such a decision.

If there is no entitlement for the tier, the process proceeds to step 312, where the security system can allow the policy access request. As discussed above, the creation of entitlement for a tier can indicate that the access to network security policies in that tier are restricted. If there is no entitlement for a tier, the security system can allow access to the network security policies in the tier. Thus, the security system can allow the policy access request.

If there is an entitlement for the tier including the network security policy, the process proceeds to step 308, where the security system can obtain a subset of user accounts authorized for the tier using the entitlement binding. For example, the security system can determine, using a mapping for the entitlement, to identify the subset of user accounts that have access to the tier including the network security policy. As discussed above, a first entitlement binding can be created for the first tier. Specifically, the first entitlement binding can be created to indicate the authorization for the first subset of user accounts to access the first collection of network security policies using data, e.g., entitlement binding data, that indicates the first subset of user accounts and the entitlement. The mapping that identifies the subset of user accounts can be the first entitlement binding. In operation, when the security system using the mapping to identify the subset of user accounts that have access to the network security policy, the security system can refer to the entitlement binding data based on the tier identifier, entitlement identifier, or both, to retrieve the subset of user accounts corresponding to the tier that includes the network security policy.

At step 310, the security system can determine i) whether the user account of the device is included in the subset of user accounts and ii) whether the operation type of the policy access request is included in the one or more types of operations defined in the entitlement. The security system can selectively allow or deny the policy access request using the entitlement that indicates the one or more types of operations that a subset of user accounts can perform on the network security policy and a result of the determination whether the user account for the device is included in the subset of user accounts that have access to the network security policy.

After the security system retrieves the subset of user accounts authorized for the tier using the mapping, the security system can determine whether the user account for the device is included in the retrieved subset of user accounts.

As discussed above, each tier may be associated with an entitlement that defines the one or more types of operations allowed to be perform in the tier by authorized user accounts. The security system can retrieve the one or more types of allowable operations for the tier including the network security policy to be accessed, e.g., the first tier, by referring to the entitlement data. The security system can determine whether the operation type of the policy access request is included in the retrieved one or more types of operations defined in the entitlement.

If both conditions are satisfied, the process proceeds to step 312, where security system allows the policy access request. Otherwise, the process proceeds to step 314, where the security system denies the policy access request.

More specifically, in response to determining that the user account of the device is not included in the subset of user accounts that have access to the network security policy, the security system denies the policy access request. For example, the security system prevents the access to the network security policy.

In response to determining that the operation type of the policy access request is not included in the one or more types of operations indicated in the entitlement for the network security policy, the security system denies the policy access request. For example, if the policy access request requests to “delete” an existing policy in the first tier, and the entitlement of the first tier defines that the allowed operation types include “read” and “create,” the security system can deny the policy access request, because the requested operation type “delete” is not included in the allowable operations “read” and “create.”

In response to determining that i) the user account for the device is included in the subset of user accounts that have access to the network security policy and ii) the operation type of the policy access request is included in the one or more types of operations indicated in the entitlement for the network security policy, the security system allows the user account to access the network security policy.

The order of steps in the process 300 described above is illustrative only, and can be performed in different orders. In some implementations, the process 300 can include additional steps, fewer steps, or some of the steps can be divided into multiple steps. For example, the process can include steps 308, 310 and 312, and optionally step 306, without the other steps in the process 300. In some examples, the process can include steps 308, 310 and 314, and optionally step 306, without the other steps in the process 300.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims, described in the specification, or depicted in the figures can be performed in a different order and still achieve desirable results. In some cases, multitasking and parallel processing may be advantageous.

What is claimed is:

1. A computer-implemented method comprising:
determining, for a policy access request i) received from a device and ii) that requests access to a network security policy that defines a rule for controlling network traffic, whether there is an entitlement for the network security policy, wherein the entitlement indicates one or more types of operations that a subset of user accounts can perform on the network security policy;
in response to determining that there is an entitlement for the network security policy, determining, using a mapping for the entitlement that identifies the subset of user accounts that have access to the network security policy, whether a user account for the device is included in the subset of user accounts that have access to the network security policy; and
selectively allowing or denying the policy access request using the entitlement that indicates the one or more types of operations that a subset of user accounts can perform on the network security policy and a result of the determination whether the user account for the device is included in the subset of user accounts that have access to the network security policy.

2. The computer-implemented method of claim 1, comprising:
in response to determining that the user account for the device is not included in the subset of user accounts that have access to the network security policy, denying the policy access request.

3. The computer-implemented method of claim 2, wherein denying the policy access request comprises preventing access to the network security policy.

4. The computer-implemented method of claim 1, comprising:
receiving, the policy access request comprising at least one of a network security policy identifier, a tier identifier, or an operation type,
wherein the operation type includes one of create, read, update, or delete.

5. The computer-implemented method of claim 4, wherein the policy access request comprises an operation type, the method comprising:
in response to determining that the operation type of the policy access request is not included in the one or more types of operations indicated in the entitlement for the network security policy, denying the policy access request.

6. The computer-implemented method of claim 1, comprising:
in response to determining that i) the user account for the device is included in the subset of user accounts that have access to the network security policy and ii) an operation type of the policy access request is included in the one or more types of operations indicated in the entitlement for the network security policy, allowing the user account to access the network security policy.

7. The computer-implemented method of claim 1, wherein:
a first tier includes a first collection of network security policies that include the network security policy,
the entitlement is created for the first tier to associate the first tier with the one or more types of operations that can be performed on the first collection of network security polices by the subset of user accounts,
a first entitlement binding indicates an authorization for the subset of user accounts to access the first collection of network security policies in the first tier, and
determining whether there is an entitlement for the network security policy comprises:
determining whether an entitlement is created for the first tier that includes the network security policy.

8. The computer-implemented method of claim 7, wherein:
a second tier includes a second collection of network security policies,
a second entitlement is created for the second tier to associate the second tier with one or more types of operations that can be performed on the second collection of network security policies by a second subset of user accounts, and
a second entitlement binding indicates an authorization for the second subset of user accounts to access the second collection of network security policies in the second tier.

9. The computer-implemented method of claim 8, wherein:
the first tier is associated with a first priority that is higher than a second priority associated with the second tier, and
during control of network traffic, the first collection of network security policies in the first tier are applied before the second collection of network security policies because the first tier has the first priority that is higher than the second priority for the second tier.

10. The computer-implemented method of claim 7, wherein determining, using the mapping, whether the user account for the device is included in the subset of user accounts that have access to the network security policy comprises:
determining, using the first entitlement binding, whether the user account for the device is included in the subset of user accounts that are authorized for the first tier.

11. The computer-implemented method of claim 7, comprising:
creating the first entitlement binding that indicates the authorization for the subset of user accounts to access the first collection of network security policies using data that identifies the subset of user accounts and the entitlement, wherein the mapping that identifies the subset of user accounts that have access to the network security policy comprises the first entitlement binding.

12. The method of claim 1, comprising:
determining, for a second policy access request i) received from a second device and ii) that requests access to a second network security policy that defines a second rule for controlling network traffic, whether there is a second entitlement a) for the second network security policy b) that indicates one or more second types of operations that a second subset of user accounts can perform on the second network security policy; and
in response to determining that there is no second entitlement for the network security policy, allowing the policy access request.

13. A system comprising one or more computers and one or more storage devices on which are stored instructions that are operable, when executed by the one or more computers, to cause the one or more computers to perform operations comprising:
determining, for a policy access request i) received from a device and ii) that requests access to a network security policy that defines a rule for controlling network traffic, whether there is an entitlement for the network security policy, wherein the entitlement indicates one or more types of operations that a subset of user accounts can perform on the network security policy;
in response to determining that there is an entitlement for the network security policy, determining, using a mapping for the entitlement that identifies the subset of user accounts that have access to the network security policy, whether a user account for the device is included in the subset of user accounts that have access to the network security policy; and
selectively allowing or denying the policy access request using the entitlement that indicates the one or more types of operations that a subset of user accounts can perform on the network security policy and a result of the determination whether the user account for the device is included in the subset of user accounts that have access to the network security policy.

14. The system of claim 13, the operations comprising:
in response to determining that the user account for the device is not included in the subset of user accounts that have access to the network security policy, denying the policy access request.

15. The system of claim 14, wherein denying the policy access request comprises preventing access to the network security policy.

16. The system of claim 13, the operations comprising:
receiving, the policy access request comprising at least one of a network security policy identifier, a tier identifier, or an operation type,
wherein the operation type includes one of create, read, update, or delete.

17. The system of claim 16, wherein the policy access request comprises an operation type, the operations comprising:
in response to determining that the operation type of the policy access request is not included in the one or more types of operations indicated in the entitlement for the network security policy, denying the policy access request.

18. The system of claim 13, the operations comprising:
in response to determining that i) the user account for the device is included in the subset of user accounts that have access to the network security policy and ii) an operation type of the policy access request is included in the one or more types of operations indicated in the entitlement for the network security policy, allowing the user account to access the network security policy.

19. The system of claim 13, wherein:
a first tier includes a first collection of network security policies that include the network security policy,
the entitlement is created for the first tier to associate the first tier with the one or more types of operations that can be performed on the first collection of network security polices by the subset of user accounts,
a first entitlement binding indicates an authorization for the subset of user accounts to access the first collection of network security policies in the first tier, and
determining whether there is an entitlement for the network security policy comprises:
determining whether an entitlement is created for the first tier that includes the network security policy.

20. A non-transitory computer storage medium encoded with instructions that, when executed by one or more computers, cause the one or more computers to perform operations comprising:
maintaining, in a database:
first data for a network security policy that (i) defines a rule for controlling network traffic and (ii) is associated with a single tier in a plurality of tiers of network security policies,
second data for each tier in the plurality of tiers of network security policies that indicates an entitlement for the tier, wherein the entitlement identifies one or more types of operations that a corresponding subset of user accounts can perform on the network security policies included in the tier, and
third data for an entitlement binding (a) for an entitlement from a plurality of entitlements (b) that identifies the corresponding subset of user accounts that can perform the one or more types of operations identified by the entitlement;
determining, for a policy access request i) received from a device and ii) that requests access to a second network security policy, whether there is an entitlement for the second network security policy in the database; and
in response to determining that there is no entitlement for the second network security policy in the database, allowing the policy access request.
